(19) United States
(12) Patent Application Publication
(10) Pub. No.: US 2026/0171741 A1
(43) Pub. Date: Jun. 18, 2026

(54) WORKPIECE LOCATOR AND CRIMPING TOOL, PRESSING TOOL, OR STRIPPING TOOL

(71) Applicant: WEZAG GmbH & Co. KG, Stadtallendorf (DE)

(72) Inventors: Thomas Glockseisen, Düsseldorf (DE); Thomas Lerch, Schwalmstadt (DE)

(73) Assignee: WEZAG GmbH & Co. KG, Stadtallendorf (DE)

(21) Appl. No.: 19/423,028

(22) Filed: Dec. 17, 2025

(30) Foreign Application Priority Data
Dec. 17, 2024 (EP) 24 220 645.6

(51) Int. Cl. H01R 43/048

(52) U.S. Cl. CPC H01R 43/048

(57) ABSTRACT

The invention relates to a workpiece locator which has a supporting body with which the workpiece locator can be fastened to a tool head. The workpiece locator has a holding body which is movable with a rotational degree of freedom relative to the supporting body. Furthermore, the workpiece locator has a positioning body which has a receptacle for a workpiece to be processed. The positioning body is movable with a further rotational degree of freedom relative to the holding body. In this way, the operation of the workpiece locator can be simplified and/or a multifunctional workpiece locator can be provided. It is also possible for at least two other degrees of freedom to be provided between the supporting body and the positioning body.

### CROSS REFERENCE TO RELATED APPLICATIONS

This application claims priority to co-pending European Patent Application No. EP 24 220 645.6 filed on Dec. 17, 2024 and entitled “Werkstück-Locator sowie Crimpwerkzeug, Presswerkzeug oder Abisolierwerkzeug”.

### FIELD OF THE INVENTION

The invention relates to a workpiece locator that is used for a tool or as a component of a tool. By means of the tool, a workpiece is processed by processing bodies. The tool may be configured as a crimping tool, in which the processing bodies form a pair of crimp die halves. By means of such a crimping tool, a crimping of a workpiece is carried out, wherein a crimping of a connector with a conductor can be performed and, for example, a so-called insulation crimp and/or a conductor crimp can be brought about. It is likewise possible that the tool is a pressing tool. In this case, the processing bodies have press die halves. By means of such a pressing tool, in particular fittings can be pressed with pipes. It is also possible that the tool is a stripping tool. In this case, the processing bodies have a stripping blade. By means of such a stripping tool, in particular, a stripping of an end section of a conductor can be carried out. The tool can also be a multifunctional tool that can be used, for example, both for stripping and for crimping.

It is possible that the tool is configured as a manually actuated hand tool or hand pliers, as a pneumatically, hydraulically, or electrically operated hand tool, or as a pneumatically, hydraulically, or electrically operated stationary machine.

In tools of the types described, workpiece locators are used, which can also be referred to as workpiece positioners. By means of the workpiece locator, prior to bringing about the processing operation in which the processing bodies are moved toward one another over a working stroke and the processing of the workpiece by pressing, crimping, or cutting takes place, the workpiece is brought into a predetermined relative position and/or orientation with respect to the tool and to the processing bodies. Alternatively or cumulatively, it is possible that the workpiece locator holds or secures the workpiece during the working stroke and under the forces exerted on the workpiece by the processing bodies in a predetermined position and/or orientation with respect to the tool.

The workpiece locator can, for example, have a stop that defines an insertion depth of the workpiece into the tool. Alternatively or cumulatively, the workpiece locator can have a receptacle into which the workpiece can be inserted and which can be embodied as a recess, wherein the receptacle can surround or support the workpiece along the entire circumference or only over a part of the circumference. The bottom or a shoulder of the receptacle can also define a position of the workpiece by defining the insertion depth of the workpiece into the receptacle of the workpiece locator. The receptacle can also define the orientation of the workpiece.

### BACKGROUND OF THE INVENTION

DE 10 2008 017 366 A1 corresponding to U.S. Pat. No. 8,161,789 B2 discloses a workpiece locator for crimping pliers. The workpiece locator is openable and closable about a folding axis that is oriented parallel to the pliers head plane as well as perpendicular to a crimp axis between an insertion position and a working position. In the insertion position, the receptacle is folded away from the pliers head plane, so that easy insertion of the workpiece into the receptacle of the workpiece locator is possible. In the working position, by contrast, the workpiece locator is folded toward the pliers head plane. In the working position, the receptacle with the workpiece accommodated therein is arranged directly adjacent to the processing bodies, and the receptacle axis of the receptacle (and thus also the workpiece arranged therein) is arranged coaxially with the die axis of the crimp die jointly formed by the two processing bodies.

EP 3 300 187 B1 corresponding to U.S. Pat. No. 11,381,048 B2 discloses a workpiece locator for crimping pliers with a corresponding folding degree of freedom. In this case, the workpiece locator comprises a latching device by which a latching or clamping of the workpiece in the receptacle of the workpiece locator is possible. The processing bodies of the crimping pliers have several pairs of crimp die halves arranged next to one another, which, in pairs, form a plurality of crimp dies. The crimp dies have different die contours so that different types and/or geometries of workpieces can be crimped with them. Accordingly, the workpiece locator has several receptacles for workpieces arranged next to one another with corresponding spacings.

EP 2 463 969 B1 corresponding to U.S. Pat. No. 8,601,856 B2 likewise discloses crimping pliers in which the processing bodies have several pairs of crimp die halves arranged one besides the other. Here the workpiece locator has only one receptacle for a workpiece. In this case, however, a positioning body of the workpiece locator forming the receptacle is held displaceably on a supporting body of the workpiece locator attached to the pliers head such that, in different operating positions of the positioning body relative to the supporting body, the receptacle can be arranged in each case behind one of the pairs of crimp die halves. The displacement of the positioning body relative to the supporting body takes place along a degree of freedom that is oriented parallel to the pliers head plane and perpendicular to the crimp axis. The operating positions of the positioning body can each be secured by a latching mechanism being a catch mechanism or locking mechanism. EP 2 463 969 B1 discloses a further embodiment in which the positioning body is not translationally displaceable relative to the supporting body, but the positioning body rather is a rotary wheel that is rotatable about an axis of rotation arranged perpendicular to the pliers head plane into the different operating positions. On the side surface facing towards the pliers head, the rotary wheel has receptacles that are arranged distributed in the circumferential direction at the same distance from the axis of rotation. In the respective operating positions brought about by rotation, one receptacle is then in each case arranged behind the pair of crimp die halves.

EP 3 312 949 B1 corresponding to US patent application US 2018/0115132 A1 on the one hand describes crimping pliers in which, corresponding to EP 2 463 969 B1, a positioning body of a workpiece locator is rotatable about an axis of rotation that is oriented perpendicular to the pliers head plane. In addition, EP 3 312 949 B1 discloses an embodiment in which the workpiece locator is foldable between a working position and an insertion position, wherein in this case the opening and closing take place about a folding axis that is oriented parallel to the pliers head plane as well as parallel to the crimp axis.

WO 2019/013687 A1 corresponding to U.S. Pat. No. 11,482,824 B2 discloses a workpiece locator with a plate-shaped positioning body which has, in the region of its narrow sides, several receptacles for a workpiece arranged next to one another. The positioning body forms a kind of slide which is guided with a translational degree of freedom in the workpiece locator which is mounted on the pliers head plane of crimping pliers to which the workpiece locator is fastened. A sensitive movement of the slide-configured positioning body along the degree of freedom in order to set the desired relative position with respect to the pliers head can be brought about by actuating a spindle drive of the workpiece locator by means of a hexagon wrench. The output movement of the spindle drive is converted into the movement of the positioning body along the degree of freedom by a relative movement of a wedge surface of the spindle nut of the spindle drive relative to a wedge surface of the positioning body.

The publications DE 92 13 529 U1, DE 20 2010 008 988 U1, DE 298 12 631 U1, DE 20 2006 012 869 U1, U.S. Pat No. 5,924,322 A, DE 27 18 165 A1, DE 198 32 884 C1 (corresponding to U.S. Pat. No. 6,155,095), U.S. Pat Nos. 4,982,594 A, 3,710,611 A, 3,457,764 A and JP 2010 009768 A disclose further embodiments of a workpiece locator in which a positioning body is provided with a degree of freedom.

### SUMMARY OF THE INVENTION

The invention proposes a workpiece locator and a tool with such a workpiece locator which is multifunctional, which provides extended options for providing a positioning of the workpiece relative to the tool and/or which is improved with regard to operation.

The workpiece locator may be mounted to a tool (which is a crimping tool, a pressing tool and/or a stripping tool) or may form a part of the tool. The workpiece locator has a supporting body which is part of the tool or has a mounting region for fastening to the tool. It is possible, for example, for the supporting body of the workpiece locator to be flanged to the tool, in particular to a tool head, a frame of the tool head, or a movable or a fixed processing body, or to be formed by the same.

In the workpiece locator, a holding body is movable with a first degree of freedom relative to the supporting body, the holding body being mounted directly or indirectly on the supporting body while ensuring this first degree of freedom.

Furthermore, the workpiece locator comprises a positioning body which has the receptacle into which the workpiece can be inserted, or has a stop for the workpiece. The positioning body is movable with a second degree of freedom, which differs from the first degree of freedom, relative to the holding body, for which purpose the positioning body is mounted directly or indirectly on the holding body while ensuring this second degree of freedom.

The first and second degrees of freedom may be any degrees of freedom, provided that they differ from one another. Thus, the first degree of freedom and the second degree of freedom
may each be rotational and/or folding degrees of freedom or degrees of freedom about different rotational and/or folding axes, or
may each be translational (straight or curved) degrees of freedom having at least partial sections with different directions, or
one of the degrees of freedom is a rotational or folding degree of freedom while the other degree of freedom is a translational degree of freedom.

Whereas, according to the prior art, the positioning body has only a single degree of freedom with respect to the supporting body, the positioning body has two degrees of freedom relative to the supporting body. This leads to an enlarged design flexibility with regard to influencing the relative position of the positioning body relative to the supporting body and thus relative to the processing bodies. Alternatively or cumulatively, the different degrees of freedom can be used to enable improved handling for the user, for example when inserting the workpiece into the workpiece locator and/or removing the workpiece from the workpiece locator. Alternatively or cumulatively, the several degrees of freedom can be used such that the workpiece locator is multifunctional or has extended functional features, in that
depending on the operating position of the positioning body along at least one of the degrees of freedom, different functional elements held on the workpiece locator can be used, and/or
the number of receptacles or stops arranged on the positioning body can be increased and, depending on the operating position along at least one of the degrees of freedom, different receptacles or stops can be brought into the operating position in alignment with the stripping blades, crimp dies or press dies of the processing bodies.

In one proposal, the first degree of freedom of the holding body is a rotational degree of freedom about an axis of rotation that is oriented perpendicular to a plane in which a processing body of the tool is moved (in particular pivoted or translationally moved or moved in a curved manner) over a working stroke of the tool on which the workpiece locator is held. Preferably, the plane with respect to which the axis of rotation is oriented perpendicular is the tool head plane of the tool. For this embodiment, the holding body is configured, for example, as a kind of revolver which is rotatable with the first degree of freedom relative to the tool. The rotation of the holding body then has the effect that, depending on the rotational position of the holding body,
different partial sections of a front face of the positioning body and receptacles or stops in these different partial sections, or
different positioning bodies arranged distributed over the circumference of the holding body
can be brought into an operating position in alignment with the processing bodies.

Preferably, for this embodiment, at least two positioning bodies are arranged on the holding body, which are arranged distributed over the circumference of the holding body. Depending on the rotational position of the holding body, one of the positioning bodies can then be selectively brought into effect. Here, the positioning bodies may in each case be movable with the second degree of freedom relative to the holding body, which gives rise to additional possibilities.

It is possible that the second degree of freedom of the positioning body relative to the holding body is likewise a rotational degree of freedom, the axis of rotation of this rotational degree of freedom being oriented perpendicular to the axis of rotation of the first degree of freedom, if the first degree of freedom is a rotational degree of freedom. In this case, the positioning body has at least two receptacles or stops which are arranged distributed over the circumference of the positioning body. Depending on the rotational position of the positioning body with respect to its rotational degree of freedom, the receptacles or stops arranged distributed over the circumference of the positioning body can then in each case be brought into the operating position in alignment with the processing bodies.

If both for the first degree of freedom of the holding body as described a rotational degree of freedom is used and for the second degree of freedom of the positioning body a rotational degree of freedom is used, then—when several positioning bodies distributed over the circumference of the holding body are used—at each positioning body, for example, X receptacles or stops can be arranged which can be brought into the operating position by a rotation about the second rotational degree of freedom, and Y positioning bodies can be arranged distributed around the circumference of the holding body, which in each case can be brought into the operating position in alignment with the processing bodies by rotation about the first rotational degree of freedom. In this case, the use of X×Y receptacles or stops can be provided by means of the workpiece locator. However, it is also possible that, when several positioning bodies are used, the positioning bodies have a different number of receptacles or stops.

According to a further proposal, the positioning body is movable relative to the holding body with a degree of freedom which is a translational (curved or straight) displacement degree of freedom. This displacement degree of freedom can be the second degree of freedom. However, it is also possible that the second degree of freedom is, for example, a rotational degree of freedom as explained above, so that the mentioned displacement degree of freedom is an additional third degree of freedom. By means of this degree of freedom, preferably the distance of the positioning body and thus of the at least one receptacle or of the at least one stop relative to the processing bodies and the tool head plane can be changed. This change in the distance can be used to set a predetermined distance or a position of the workpiece relative to the processing bodies or to allow an adaptation for different types of workpieces and/or processing bodies with different dies or stripping blades. It is likewise possible for this displacement degree of freedom to be used to improve the insertion of the workpiece into a receptacle and/or the removal of the workpiece from the receptacle.

The displacement degree of freedom can be provided by any direct or indirect mounting between the positioning body and the holding body or by a suitable guiding device. In one proposal, the translational displacement degree of freedom, i.e. the second or third degree of freedom, is provided by means of a slide. Here, it is also possible for the displacement degree of freedom to be latchable by a latching device, thereby enabling a securing of an operating position brought about by the displacement. A latching device is any device by which the displacement degree of freedom can be fixed. The latching device can be configured, for example, as a snap or locking device, can be configured with a securing pin, or can be a screw or clamping device. In the simplest case, the displacement degree of freedom can be embodied by a suitable guiding groove of the holding body or the positioning body, in which at least one nut of the other one of the holding body and the positioning body is guided in a sliding manner.

The translational displacement degree of freedom of the slide can provide any length, i.e. any slide path that ensures the different required operating positions of the slide. In a particular proposal, the slide path is dimensioned such that, by the movement of the slide, an insertion of the positioning body between the opened processing bodies of the tool is possible. It is even possible that the slide path is dimensioned such that the positioning body can be pushed through an intermediate space between the processing bodies in such a way that a front face of the positioning body (and thus a receptacle for a workpiece in this front face) protrudes at least slightly from the opened processing bodies on a side of the tool that is opposite the side of the tool on which the holding body is arranged. Whereas, according to the prior art, the insertion of the workpiece takes place on the side on which the holding body is arranged, for the described dimensioning of the slide path it can also be enabled that the insertion of the workpiece takes place from the other side, whereby insertion (in particular for very small workpieces) can be simplified.

In a further proposal, the slide is guided in a T-groove of the holding body [or of the positioning body]. In this case, the slide can have at least one T-nut. In an assembly position, the T-nut can be insertable from above into an opening of the T-groove, while, remote from this opening, the T-nut can be guided in the T-groove with the translational displacement degree of freedom, i.e. with the second or third degree of freedom. This embodiment enables a simple assembly and, if appropriate, also disassembly of the slide from the holding body or positioning body, whereby, depending on the application, different slides can also be used together with the holding body or positioning body.

In one embodiment, the slide forms a stop for a workpiece. In the simplest case, the slide is then (to a first approximation) L-shaped, wherein one leg of the L is oriented in the direction of the translational degree of freedom and provides the displacement degree of freedom and may, in one embodiment, carry the T-nuts, while the other leg of the L then forms a stop for the workpiece.

An embodiment is also proposed in which the positioning body is mounted with a folding degree of freedom on the holding body, which allows the positioning body to be opened and closed relative to the holding body (i.e. folded toward the tool head plane and folded away from it). This folding degree of freedom can be the second degree of freedom. However, it is also possible for this folding degree of freedom to be provided as an additional fourth degree of freedom for the positioning body. For example, it is possible for the holding body to have a first rotational degree of freedom, for several positioning bodies to be arranged around the circumference of the holding body with a second rotational degree of freedom, and for at least one of the positioning bodies then to be movable relative to the holding body with a fourth folding degree of freedom. Optionally, the displacement degree of freedom can then additionally also be present.

For a particular embodiment, the folding degree of freedom can provide the folding axis for opening and closing by means of a T-nut arranged in the T-groove. In this case, the cross legs of the T-nut guided in the undercuts of the T-groove can form the pivot pins defining the folding axis.

In the embodiments described above, it is possible for at least one of the mentioned degrees of freedom (at least one of the rotational degrees of freedom and/or of the displacement degree of freedom and/or the folding degree of freedom) can be latched by a latching device. There are many possibilities for the configuration of the latching device.

In one proposal, the first degree of freedom, which in this case is a rotational degree of freedom, is latched and released in that the holding body is displaceable, with and against the action of a latching spring, in the direction of the axis of rotation of the first rotational degree of freedom between a latched position and an unlatched position. Here, in the latched position, a latching projection of the supporting body [or of the holding body] is arranged in a latching recess of the holding body [or of the supporting body], whereby the first rotational degree of freedom is latched. In the unlatched position, by contrast, the latching projection of the supporting body [or of the holding body] is arranged outside the latching recess of the holding body [or of the supporting body], whereby the first rotational degree of freedom is released. Preferably, in this case, the supporting body and/or the holding body have several latching projections or latching recesses which can in each case secure different rotational positions as operating positions.

It is possible for the second degree of freedom, which in this case is a rotational degree of freedom, to be latched and released in that the positioning body is displaceable, with and against the action of a latching spring, in the direction of the axis of rotation of the second rotational degree of freedom relative to the holding body between a latched position and an unlatched position. In the latched position, a latching projection of the positioning body [or of the holding body] is arranged in a latching recess of the holding body [or of the positioning body], whereby the second rotational degree of freedom is blocked. Instead, in the unlatched position, the latching projection of the positioning body [or of the holding body] is arranged outside the latching recess of the holding body [or of the positioning body], whereby the second rotational degree of freedom is released. In this case as well, several latching projections and/or latching recesses can be provided on the positioning body and/or on the holding body in order to be able to secure different operating positions of the positioning body relative to the holding body.

As explained, it is possible for several receptacles or stops to be arranged distributed around the circumference of the positioning body, which can be brought into alignment with the processing bodies in different operating positions of the positioning body. Here, the receptacles can in each case be arranged in the region of one of the several front faces of the positioning body. In this embodiment it is also possible for a workpiece to be inserted into a receptacle that is rotated away from the pairs of processing bodies. The receptacle is then, before carrying out the working stroke of the tool, rotated into the operating position in which the receptacle is aligned with the processing bodies and is arranged directly adjacent thereto or in the tool head plane. In this way, the insertion of the workpiece into the receptacle can be simplified.

In a further proposal, several receptacles or stops are arranged one besides the other on one front face of the positioning body. This is particularly advantageous when the processing bodies likewise have, arranged next to one another, several work stations, i.e. several stripping blades, several crimp dies or several press dies. The several receptacles or stops of the positioning body in the region of one front face can then in each case be used for the positioning and alignment of the workpiece with the different work stations.

A crimping tool, pressing tool and/or stripping tool can be equipped with a workpiece locator as described above. Here, the workpiece locator can be attached to the tool as an additional assembly or flanged thereto with the supporting body. However, it is also possible for the workpiece locator or at least the supporting body of the workpiece locator to be an integral part of the crimping tool, pressing tool and/or stripping tool. As mentioned at the outset, the crimping tool, pressing tool or stripping tool can be a hand tool that is operated manually or by means of an electric, pneumatic or hydraulic drive, or can be a machine tool.

Advantageous developments of the invention result from the patent claims, the description and the drawings.

The advantages of features and of combinations of several features mentioned in the description are merely exemplary and may come into effect alternatively or cumulatively, without it being necessary for the advantages to be necessarily achieved by embodiments according to the invention.

With regard to the content of disclosure-not the scope of protection—of the original application documents and of the patent, the following applies: Further features can be taken from the drawings—particularly from the geometries shown and the relative dimensions of several components with respect to one another as well as their relative arrangement and operative connection. The combination of features of different embodiments of the invention or of features of different patent claims is likewise possible deviating from the selected back-references of the patent claims and is hereby encouraged. This also concerns such features that are shown in separate drawings or are mentioned in their description. These features can also be combined with features of different patent claims. Likewise, the features listed in the patent claims can be dispensed with for further embodiments of the invention, which, however, does not apply to the independent patent claims of the granted patent.

The features mentioned in the patent claims and the description are to be understood with regard to their number such that exactly this number or a greater number than the mentioned number is present, without the explicit use of the adverb “at least” being necessary. Thus, if, for example, one element is mentioned, this is to be understood such that exactly one element, two elements or more elements are present. The features mentioned in the patent claims can be complemented by further features or can be the only features that the subject matter of the respective patent claim has.

The reference numerals contained in the patent claims do not constitute a limitation of the objects protected by the patent claims. They merely serve the purpose of making the patent claims easier to understand.

### BRIEF DESCRIPTION OF THE DRAWINGS

In the following, the invention will be further explained and described with reference to preferred embodiments shown in the figures.

FIG. 1 shows in a spatial view a tool head of crimping pliers with a workpiece locator fastened thereto.

FIG. 2 shows in a spatial view the workpiece locator according to FIG. 1.

FIG. 3 shows in a spatial exploded view the workpiece locator according to FIGS. 1 and 2.

FIGS. 4 to 6 show, in spatial views, a pliers head of a crimping tool with a workpiece locator according to FIGS. 1 to 3 fastened thereto, the workpiece locator being in different operating positions with regard to its degrees of freedom.

FIG. 7 shows, in a spatial view, a further embodiment of a workpiece locator in which a movement of a slide carrying a positioning body takes place along a measuring scale.

FIG. 8 shows, in a schematic sectional view, a workpiece locator in a latched position of a latching device which latches a rotational degree of freedom of a holding body relative to a supporting body.

FIGS. 9 and 10 show, in spatial views, embodiments of a workpiece locator with positioning bodies with different outer geometries and front faces and different integrations of the receptacles in the positioning bodies.

FIGS. 11 and 12 show, in schematic sectional views, an assembly of a slide carrying a positioning body with a T-groove of a holding body in different assembly steps.

FIGS. 13 and 14 show, in schematic sectional views, the workpiece locator according to FIGS. 11 and 12 after assembly in different operating positions of the slide with the positioning body relative to the holding body along a translational degree of freedom of the slide.

FIG. 15 shows, in a spatial view, a pliers head with a workpiece locator fastened thereto, a positioning body being moved by means of a slide through opened processing bodies of the tool head from one side of the pliers head to the other side of the pliers head.

FIGS. 16 and 17 show, in spatial views, an embodiment of a workpiece locator in which a positioning body is formed by a slide which provides a stop for a workpiece.

### DETAILED DESCRIPTION

In the following description of the figures, for components or features that correspond or are similar with regard to design and/or function, partly the same reference numeral is used, these components or features then being distinguished from one another by an additional letter a, b or an additional digit “−1”, “−2”. Reference to these components or features may then also be made by the reference numeral without using the additional letter or the additional digit, meaning one or any number of these components or features.

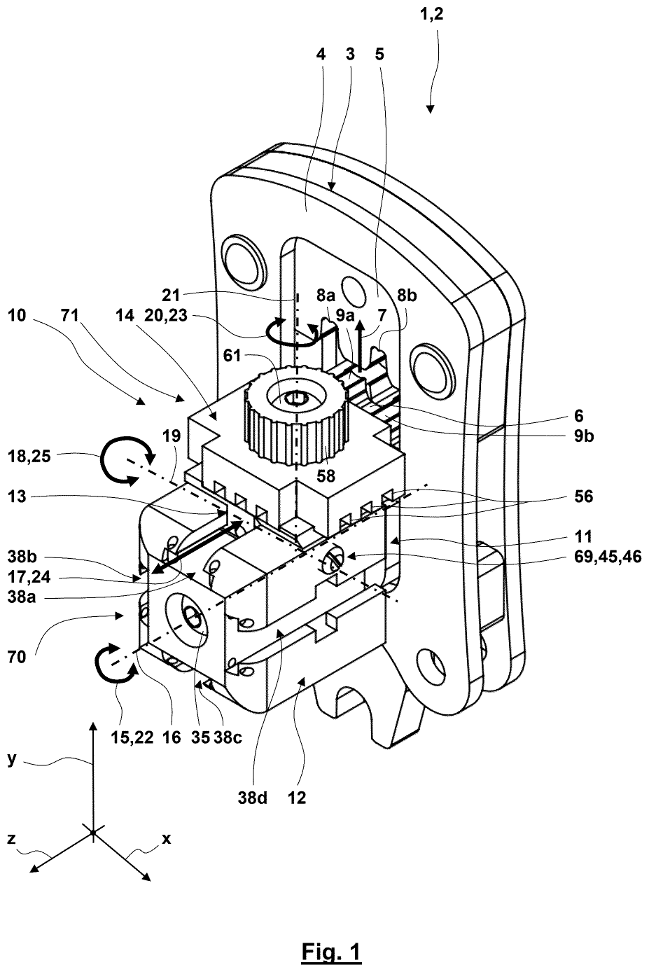

FIG. 1 shows a part of a tool 1 (being manually actuated crimping pliers 2) in the region of a crimping pliers head or tool head 3. The tool head 3 has a frame 4 on which a processing body 5 is fixed, while a further processing body 6 is movable over a working stroke in a processing direction 7. The processing bodies 5, 6 have, in a direction transverse to the processing direction 7, pairs of crimp die halves 8a, 9a; 8b, 9b arranged next to one another, one of these pairs of crimp die halves 8a, 9a; 8b, 9b in each case forming a crimp die by which a connector can be crimped.

The tool head 3 defines a tool head plane which runs parallel to the plane spanned by the axes y, y in FIG. 1. The processing direction 7 extends parallel to this tool head plane and in the direction of the Y-axis. Instead, the pairs of the crimp die halves 8, 9 are arranged spaced apart from one another in the direction of the x-axis.

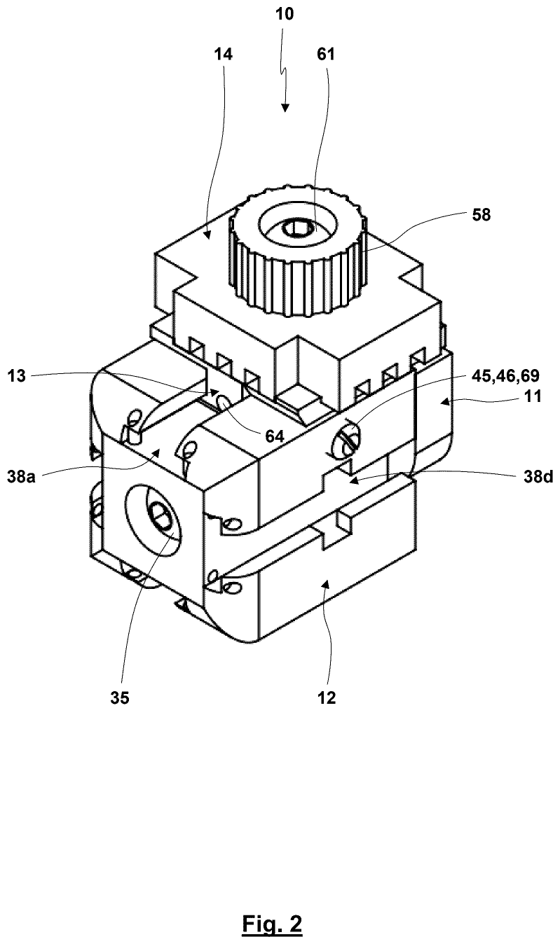

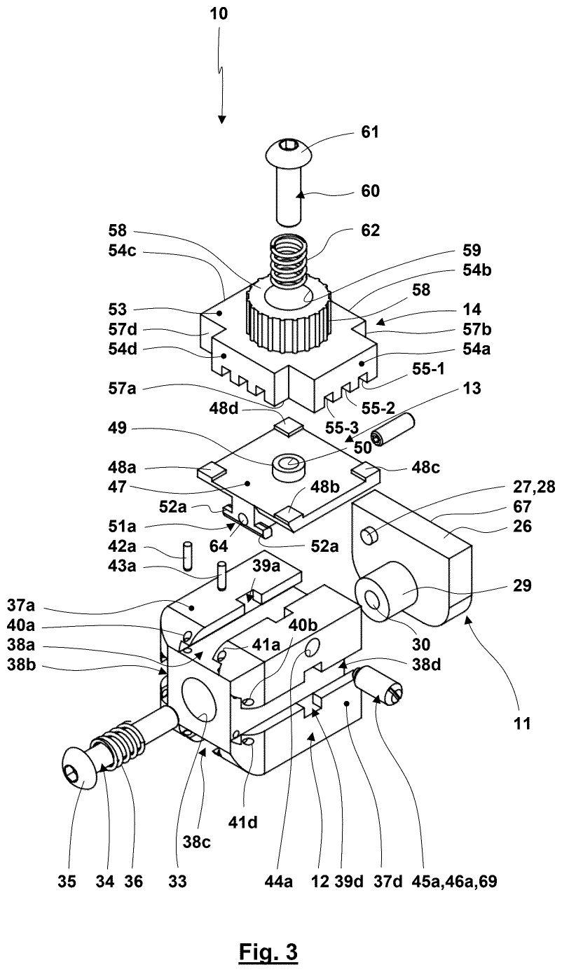

A workpiece locator 10 is fastened to the tool head 3, the workpiece locator 10 being shown in FIG. 2 without the tool head 3 and in FIG. 3 in an exploded view.

According to FIG. 3, the workpiece locator 10 has a supporting body 11, a holding body 12, a slide 13 and a positioning body 14. By suitable bearings and/or guides, the following degrees of freedom of the components of the workpiece locator 10 are provided:
The holding body 12 can be rotated relative to the supporting body 11 with a rotational degree of freedom 15 about an axis of rotation 16. The axis of rotation 16 is oriented perpendicular to the tool head plane 3.
The slide 13 can be moved relative to the holding body 12 along a translational displacement degree of freedom 17. The displacement degree of freedom 17 is oriented parallel to the axis of rotation 16.
The positioning body 14 is movable relative to the slide 13 with a folding degree of freedom 18 about a folding axis 19. The folding axis 19 is oriented parallel to the tool head plane and (in the operating position shown in FIG. 1) perpendicular to the processing direction 7.
The positioning body 14 is rotatable with a rotational degree of freedom 20 about an axis of rotation 21 relative to the slide 13. The axis of rotation 21 is, in the operating position shown in FIG. 1, oriented parallel to the tool head plane and (in the operating position shown in FIG. 1) oriented parallel to the processing direction 7.

In the embodiment shown, the rotational degree of freedom 15 forms a first degree of freedom 22, the rotational degree of freedom 20 forms a second degree of freedom 23, the displacement degree of freedom 17 forms a third degree of freedom 24, and the folding degree of freedom 18 forms a fourth degree of freedom 25 along which the positioning body 14 is movable relative to the holding body 12. However, embodiments are also possible in which any one of the degrees of freedom mentioned or any two of the degrees of freedom mentioned are omitted. For example, the workpiece locator 10 can be configured without the slide 13 and without the displacement degree of freedom 17 and/or without the folding degree of freedom 18, so that only the rotation of the holding body 12 relative to the supporting body 11 along the first degree of freedom 22 as well as the rotation of the positioning body 14 relative to the holding body 12 along the second degree of freedom 23 are possible. In particular, the third and/or fourth degrees of freedom 24, 25 are thus only optional.

As can be seen in FIG. 3, the supporting body 11 has a plate-shaped base body 26, the rear side of which bears against the associated component of the tool head 3 (in particular the frame 4 or a processing body 6). The base body 26 is fastened in a mounting region 67 to this component of the tool head 3 by a screw connection or flange connection (not shown).

On the side facing towards the holding body 12, the supporting body 11 has a latching projection 27, which is here configured as a latching pin 28. Furthermore, on this side, the supporting body 11 comprises a bearing sleeve 29 which has a cylindrical outer bearing surface and an inner threaded bore 30. In the embodiment shown, the latching projection 27 and the bearing sleeve 29 are formed in one piece with the base body 26 and extend parallel to the axis of rotation 16.

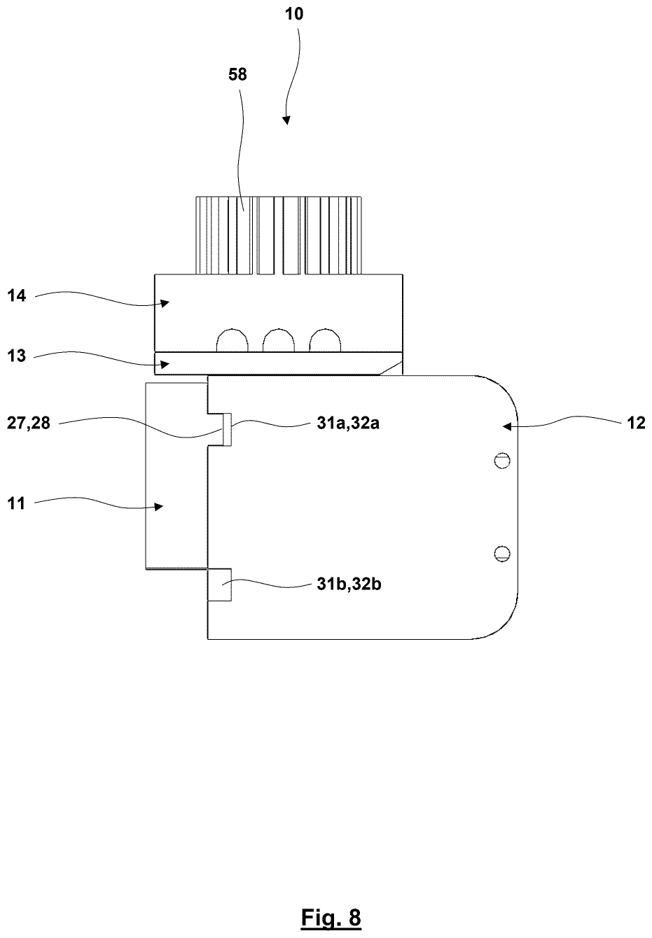

The holding body 12 is configured, to a first approximation, cuboid- or cube-shaped. On the rear front face, which is not visible in FIG. 3 and which faces the supporting body 11, the holding body 12 has latching recesses 31 which are configured as latching bores 32 (cf. FIG. 8). The latching bores 32 have a depth and a diameter such that the latching pin 28 can be received therein for latching the rotational degree of freedom 15. Here, four latching bores 32 are arranged distributed about the axis of rotation 16 in such a way that, in each case after a rotation of the holding body 12 by 90° about the axis of rotation 16, the latching pin 28 can enter one of the latching bores 32.

The holding body 12 has a stepped through bore 33. On the side facing towards the supporting body 11, the through bore has an enlarged inner cylindrical bearing surface by which the holding body 12 is mounted rotatably on the cylindrical bearing surface of the bearing sleeve 29 of the supporting body 11.

Through the through bore 33, a bearing and/or fastening bolt 34 is screwed into the threaded bore 30 of the bearing sleeve 29 of the supporting body 11. The holding body 12 is captured with a play between a head 35 of the bearing and/or fastening bolt 34 and the base body 26 of the supporting body 11. A latching spring 36 is supported with one spring base on the head 35 of the bearing and/or fastening bolt 34, while the other spring base of the latching spring 36 is supported on the front face of the holding body 12 facing away from the supporting body 11 or on a step of the through bore 33. The latching spring 36 is preloaded so that it biases the holding body 12 with the preload force towards the supporting body 11 and the latching pin 28 is pressed with this preload force into the latching bore 32. If manual tensile forces are applied to the holding body 12, with which with an increase in the loading of the latching spring 36 the holding body 12 is pulled away from the supporting body 11 and thus the latching bore 32 is pulled away from the latching pin 28, the latching can be released and a manual rotation of the holding body 12 about the axis of rotation 16 can take place.

The cuboid holding body 12 has four side surfaces 37a, 37b, 37c, 37d. T-grooves 38 are introduced into the side surfaces 37, which are continuous and thus open at the end. The T-grooves 38 extend parallel to the axis of rotation 16 in the side surfaces 37.

In the end region facing away from the supporting body 11, the undercuts of the T-grooves can be closed, thereby providing stops that limit movement of a T-nut 51 in the T-groove 38. In the embodiment shown, the undercuts in the outer end region have bores 40, 41 in which pins 42, 43 are accommodated to provide these stops.

Approximately centrally, the T-grooves 38 have an opening 39 in the region of which the undercut otherwise formed by the T-groove 38 is not present. In the region of the openings 39, a threaded bore 44 that extends from an adjacent side surface 37 opens into the T-groove 38, into which a latching element 45 (here a set screw 46) can be screwed, which forms a latching device 69 by which the displacement degree of freedom 17 can be latched.

In the embodiment shown, the slide 13 has a plate-shaped base body 47, the geometry of which in the main extension plane is square or rectangular and corresponds to the geometry of the assigned side surface 37. On the side facing away from the holding body 12, the base body 47 has latching projections 48a, 48b, 48c, 48d in the region of the corners. Furthermore, on the side of the base body 47 facing away from the holding body 12, the base body 47 has a central bearing sleeve 49, the outer peripheral surface of which forms a cylindrical bearing surface and which has an inner threaded bore 50.

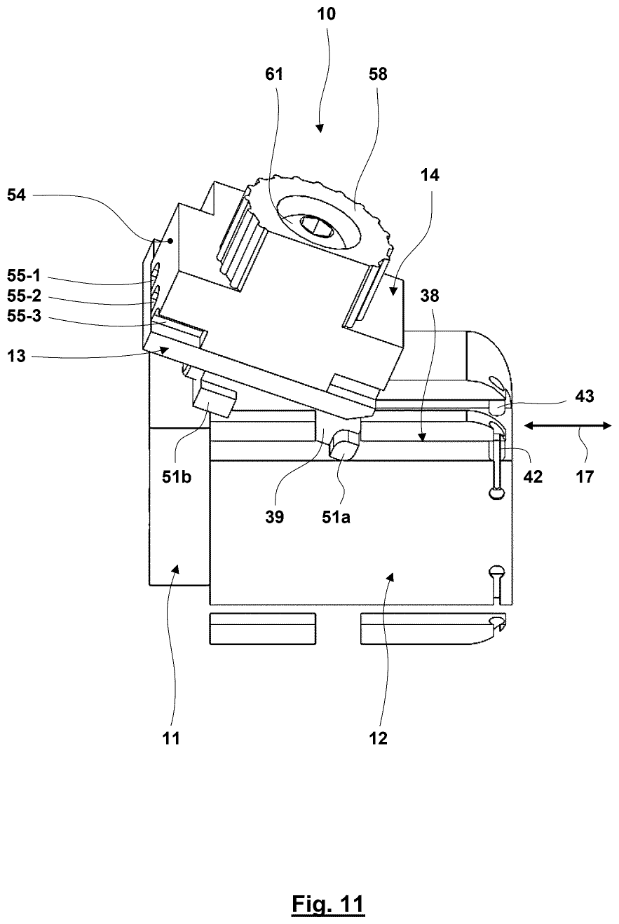

On the side facing towards the holding body 12, the slide 13 has two T-nuts 51a, 51b (see also FIGS. 11 to 14). Here, the T-nut 51a visible in FIG. 3 is arranged in the end region of the base body 47 facing away from the supporting body 11, while the other T-nut 51b is arranged at a distance from the T-nut 51a that correlates with the distance of the opening 39 from the stops formed by the pins 42, 43.

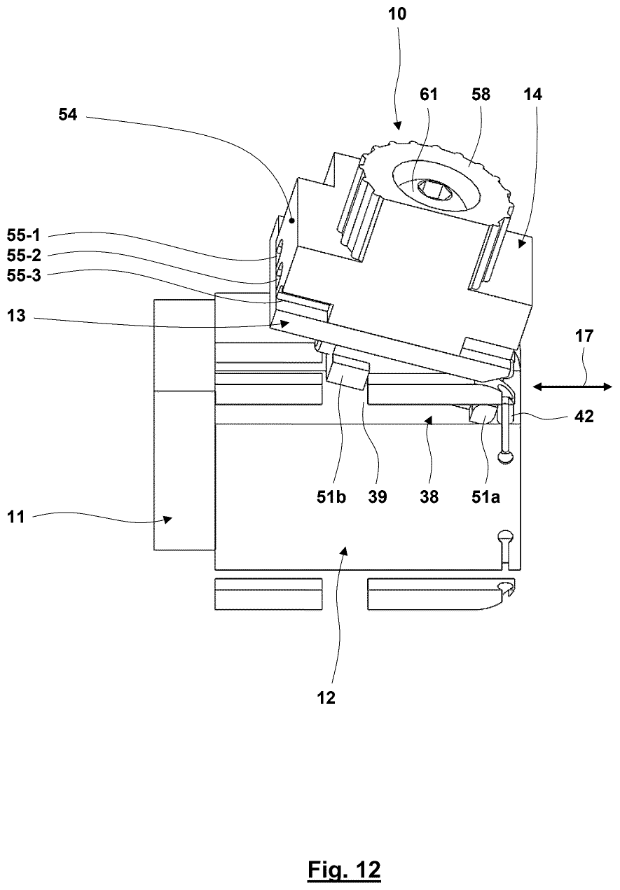

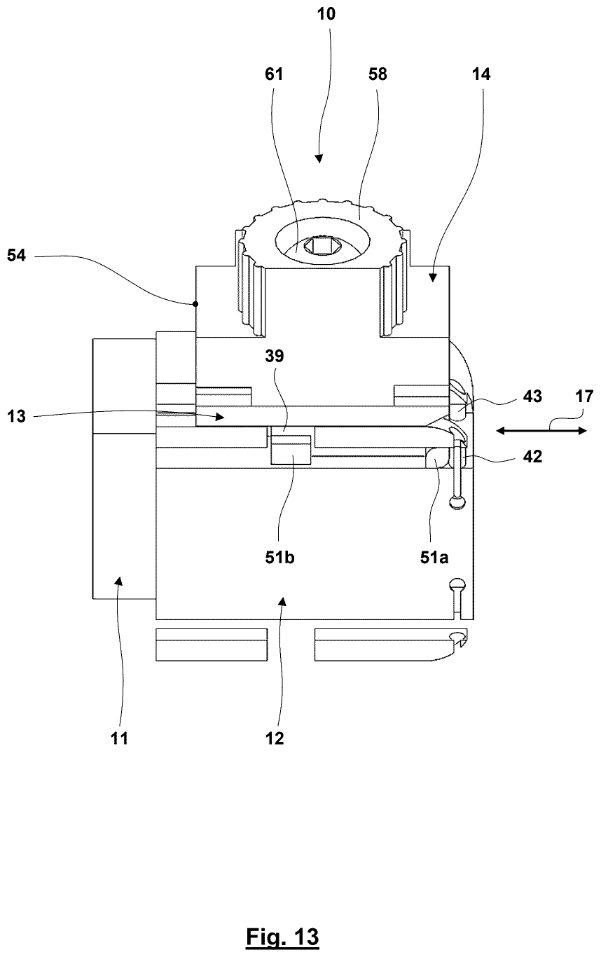

In an orientation of the base body 47 inclined under an acute angle with respect to the side surface 37a (cf. FIG. 11), the T-nut 51a can be inserted into the T-groove 38a through the opening 39a and moved therein towards the stops formed by the pins 42, 43 (cf. FIG. 12). In the end position defined by the stops, the base body 47 can then be folded toward the side surface 37a with a reduction of the acute angle, whereby the T-nut 51b also enters the T-groove 38a through the opening 39a (cf. FIG. 13).

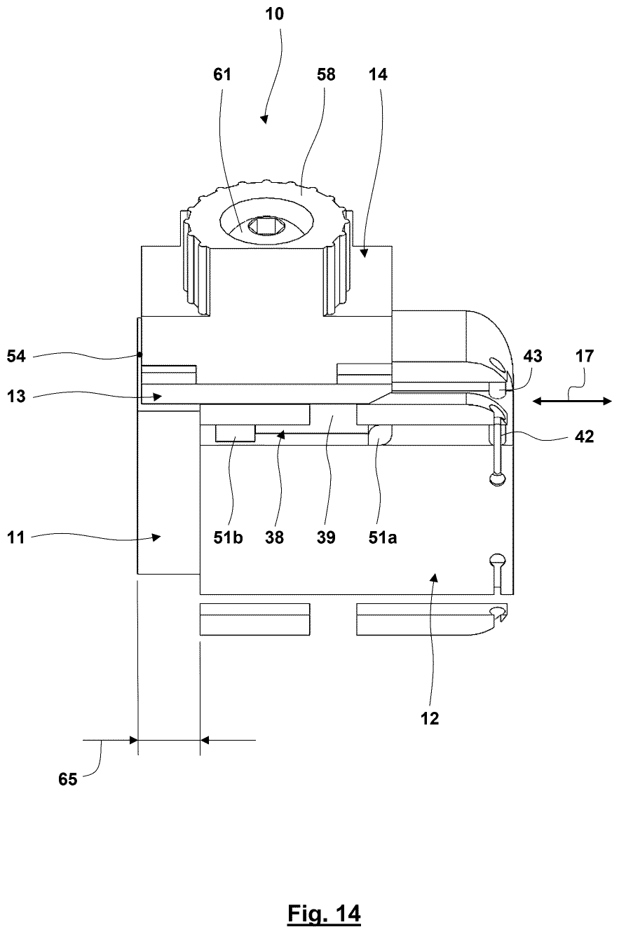

If the slide 13 is subsequently displaced away from the stops in the direction of the supporting body 11 (cf. FIG. 14), both T-nuts 51a, 51b are captured in the T-groove 38a but are displaceable in the direction of the displacement degree of freedom 17. Over a slide path, the T-nuts 51a, 51b are arranged in the T-groove 38a at locations remote from the opening 39 a so that they cannot exit the T-groove 38a.

If, by contrast, the T-nut 51b is arranged below the opening 39a (which is preferably the case when the other T-nut 51a bears against the stops provided by the pins 42, 43), a pivoting of the slide 13 can take place about the pivot pins formed by the cross legs 52 of the T-nut 51a in the T-groove 38a, whereby the folding degree of freedom 18 about the folding axis 19 is provided. The folding degree of freedom 18 is thus present only in a predetermined position, in particular in the end position defined by the stops, although, depending on the dimensioning of an oversize of the extension of the opening 39a in the direction of the displacement degree of freedom 17, the folding degree of freedom 18 can also be provided in a partial section of the displacement degree of freedom 17.

The positioning body 14 has a base body 53 which has an essentially rectangular base surface and is configured as a cuboid. The base body 53 has four front faces 54a, 54b, 54c, 54d which are oriented in pairs at right angles to one another. Sets with several receptacle halves 55-1, 55-2, 55-3 are introduced next to one another into the front faces 54. The receptacle halves 55 are each closed by the base body 47 of the slide 13 to form receptacles 56 that are closed in cross section when the positioning body 14 bears in the latched operating position on the slide 13.

In the corners, the base body 53 has latching recesses 57a, 57b, 57c, 57d.

Centrally, a knurled wheel 58 extends from the base body 53 on the side facing away from the slide 13. A through bore 59 extends centrally through the knurled wheel 58 and the base body 53. A bearing and/or fastening bolt 60 extends through the through bore 59, the end region of the bearing and/or fastening bolt 60 opposite a head 61 being screwed into the threaded bore 50 of the slide 13. The positioning body 14 is captured between the head 61 and the base body 47 of the slide 13 with an axial play. A preloaded latching spring 62 is supported with one spring base on the head 61, while the other spring base bears against a step of the through bore 59. The latching spring 62 presses the positioning body 14 towards the slide 13. In a latched operating position, the latching projections 48 of the slide 13 are received in the latching recesses 57 of the positioning body 14, whereby a latching of the rotational degree of freedom 20 of the positioning body 14 relative to the slide 13 about the axis of rotation 21 is provided. If manual tensile forces are applied by the user to the knurled wheel 58 in such a way that the positioning body 14 is pulled away from the slide 13 against the loading by the latching spring 62, the latching projections 48 exit from the latching recesses 57, whereby via the knurled wheel 58 the rotation of the positioning body 14 about the axis of rotation 21 relative to the slide 13 can take place until the latching recesses 57 can enter into latching projections 48 that had previously been arranged adjacent.

To simplify the illustration and promote clarity, in the figures only one T-groove 38a is equipped with a slide 13 and a positioning body 14. One, two or all three additional T-grooves 38 can also be equipped with a slide 13 and a positioning body 14.

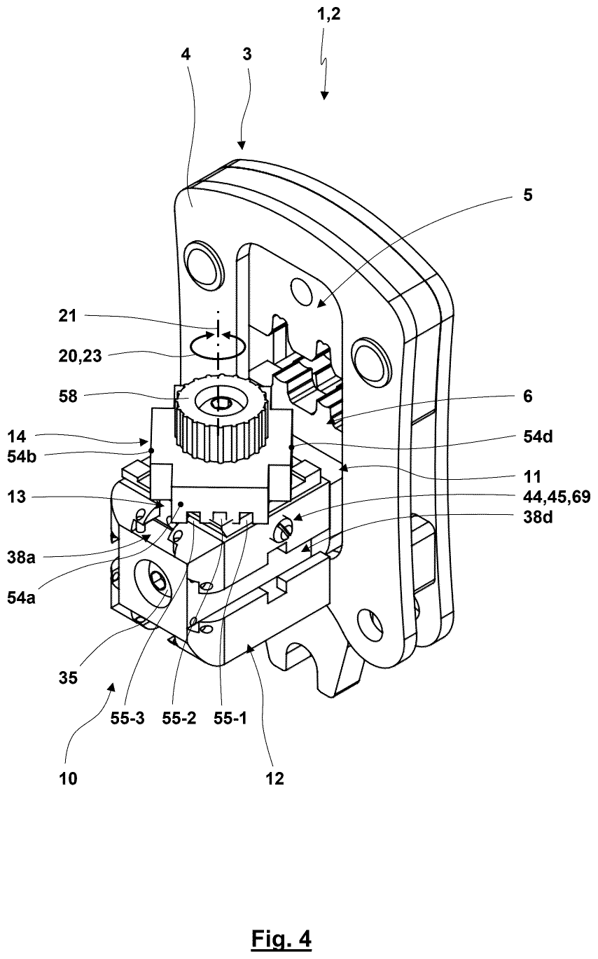

FIG. 4 shows the tool head 3 with the workpiece locator 10, the holding body 12 being in a latched operating position relative to the supporting body 11. By contrast, the positioning body 14, which is located in the T-groove 38a arranged at the top, is not in a operating position latched relative to the slide 13. Thus, none of the receptacles 56 of the positioning body is aligned with the processing bodies 5, 6, here with the pairs of die halves 8, 9. Rather, for this purpose, a rotation of the positioning body 14 according to the rotational degree of freedom 20 about the axis of rotation 21 would have to take place until a latching of the positioning body 14 relative to the slide 13 occurs, which, as a result of the action of the latching spring 62, can also be sensed by the user on the basis of a snapping-in of the latching projections 48 into the latching recesses 57. In operating positions each rotated by 90° about the axis of rotation 21, the different receptacles 56 of the front faces 54a, 54b, 54c, 54d of the positioning body 14 can then, in each case, be arranged in alignment with the processing bodies 5, 6 or die halves 8, 9.

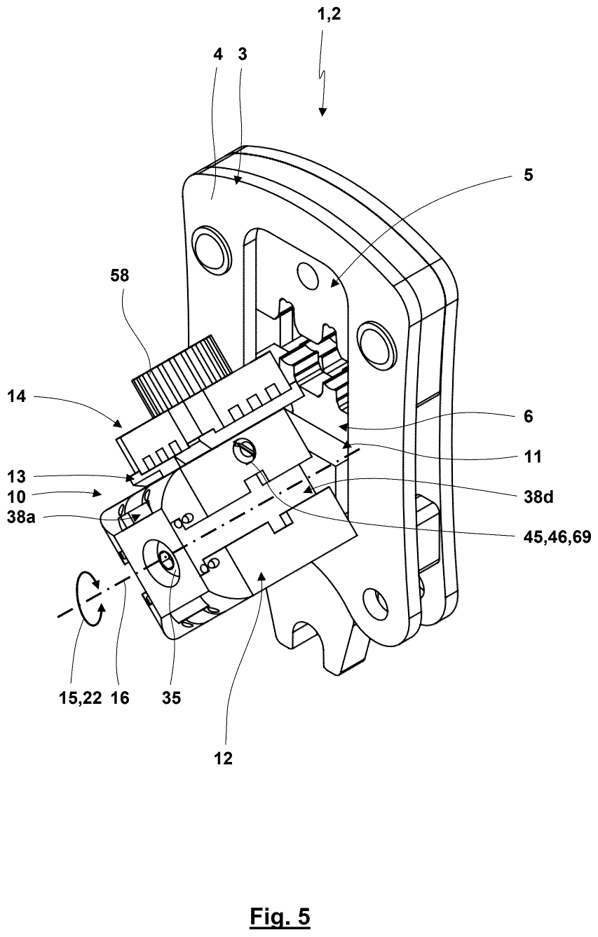

According to FIG. 5, by pulling the holding body 12 away from the supporting body 11 against the loading by the latching spring 36, the engagement of the latching projection 27 in the latching recess 31 is eliminated, whereby a rotation of the holding body 12 about the axis of rotation 16 has become possible and has been brought about.

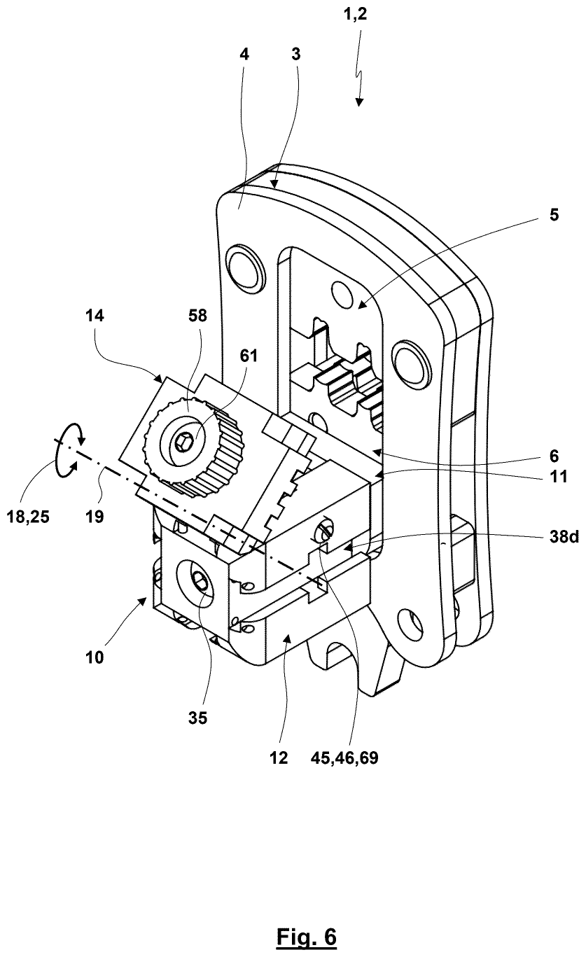

According to FIG. 6, the T-nut 51a is moved into its end position, whereby the other T-nut 51b is arranged exactly below the opening 39 of the T-groove 38. In this operating position of the slide 13, the folding degree of freedom 18 is released and a folding of the slide 13 (together with the positioning body 14) about the folding axis 19 has taken place.

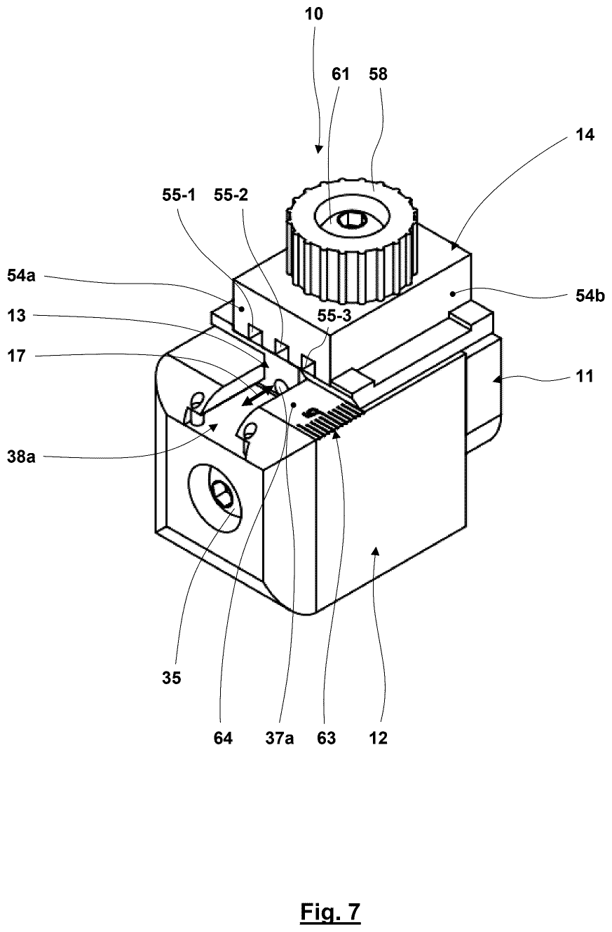

FIG. 7 shows another embodiment of a workpiece locator 10. With a design that otherwise fundamentally corresponds to the embodiment according to FIGS. 1 to 6, the holding body 12 here has a measuring scale 63 in the region of a side surface 37a. On the basis of the measuring scale 63, the user can determine which operating position the slide 13 (and thus also the positioning body 14) has adopted relative to the holding body 12 along the displacement degree of freedom 17.

It is possible for a threaded bore 64 to extend through the slide 13 in the direction of the displacement degree of freedom 17. A spindle, which is not shown here, can extend through the threaded bore 64 which is mounted on the holding body 12 so as to be rotatable but without an axial degree of freedom. By a manual rotation of the spindle, a particularly sensitive adjustment and securing of the position of the slide 13 along the displacement degree of freedom 17 is possible.

It is possible that, as shown in FIG. 7, the holding body 12 has only one T-groove 38a in the region of a side surface 37a. Furthermore, for the embodiment shown in FIG. 7, at least one front face 54b of the positioning body 14 is not equipped with receptacle halves 55.

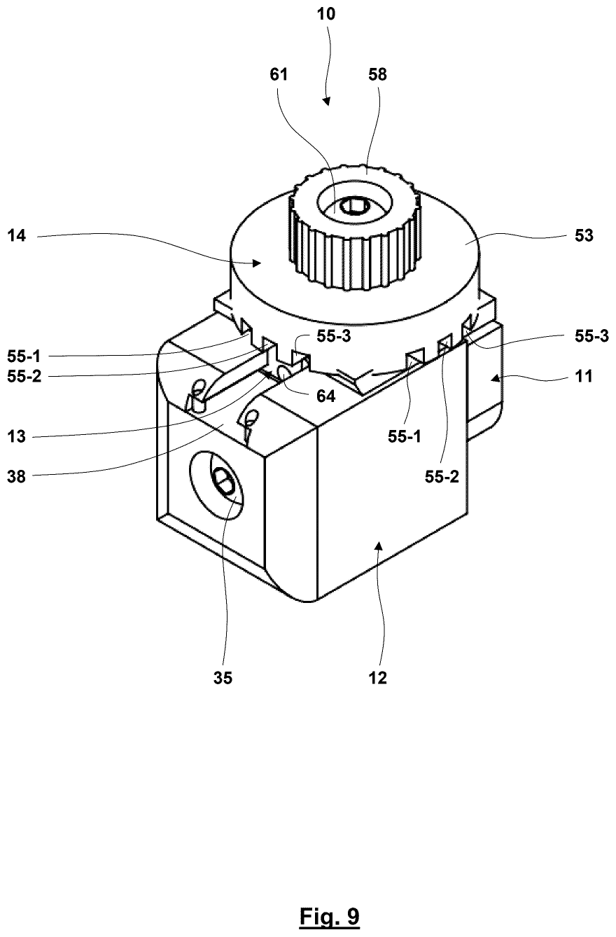

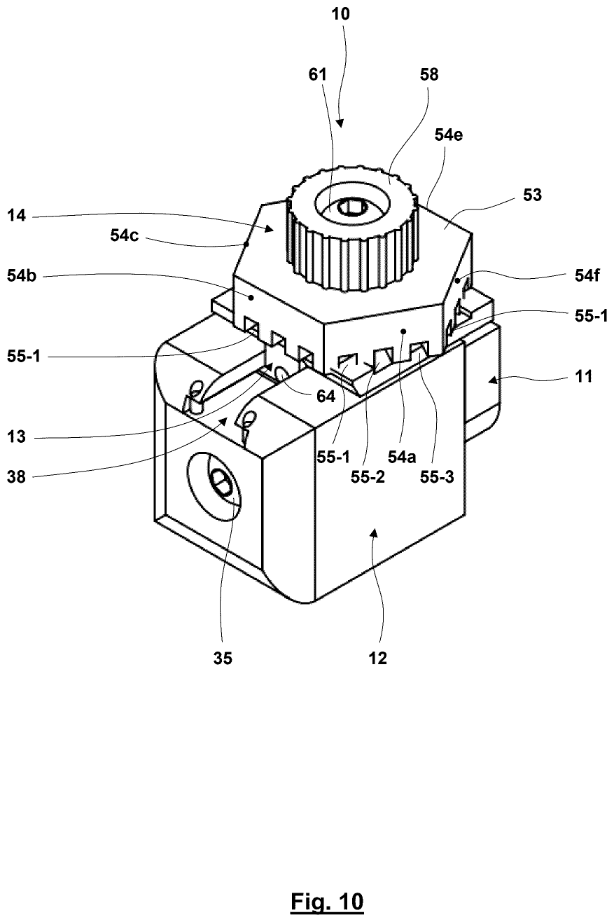

FIGS. 9 and 10 show examples of a different configuration of the base body 53 of the positioning body 14 as well as of the arrangement (sets) of the receptacle halves 55 or receptacles 56 on the positioning body 14:

According to FIG. 9, the base body 53 has a cylindrical peripheral surface. Several sets of receptacle halves 55 or receptacles 56, which are in each case assigned to the pairs of die halves 8, 9, are in this case arranged distributed over the circumference of the base body 53.

According to FIG. 10, the base body 53 has a hexagonal geometry, thereby forming six front faces 54, in which, in each case, assigned sets of receptacle halves 55 or receptacles 56 can then be arranged.

FIG. 11 shows the insertion of the slide 13 with the T-nut 51a in a slightly inclined state of the slide 13 through the opening 39 into the T-groove 38. The slide 13 can then be moved relative to the holding body 12 (while maintaining the inclination) along the displacement degree of freedom 17 towards the stops formed by the pins 42, 43, whereby the T-nut 51a slides in the T-groove 38, while the T-nut 51b approaches the opening 39 outside the T-groove 38. In the end position according to FIG. 12, in which the T-nut 51a bears against the pins 42, 43, the slide 13 can be folded towards the holding body 12, whereby the T-nut 51b enters the T-groove 38 through the opening (transition from FIG. 12 to FIG. 13). The slide 13 can now be displaced again towards the the tool head 3, i.e. in the direction of the supporting body 11, both T-nuts 51a, 51b being guided in a sliding manner in the T-groove 38. In an end position shown in FIG. 14, a movement may have taken place such that the front face 54 located in the operating position or the receptacle half (or halves) 55 or receptacle(s) 56 located in the operating position even protrude beyond the holding body 12 by a distance 65.

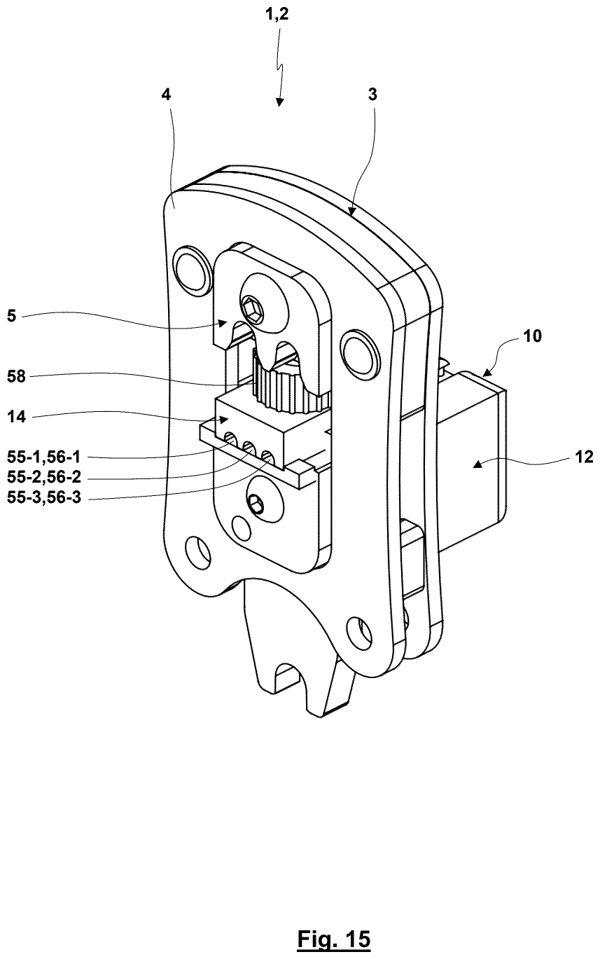

As can be seen in FIG. 15, this protruding operating position can be used so that the positioning body 14 passes through the opened processing bodies 5, 6, so that the receptacle halves 55 and receptacles 56 are arranged and accessible on the side of the tool head 3 on which the supporting body 11 and the holding body 12 are not arranged, so that insertion of the workpiece can take place from this side.

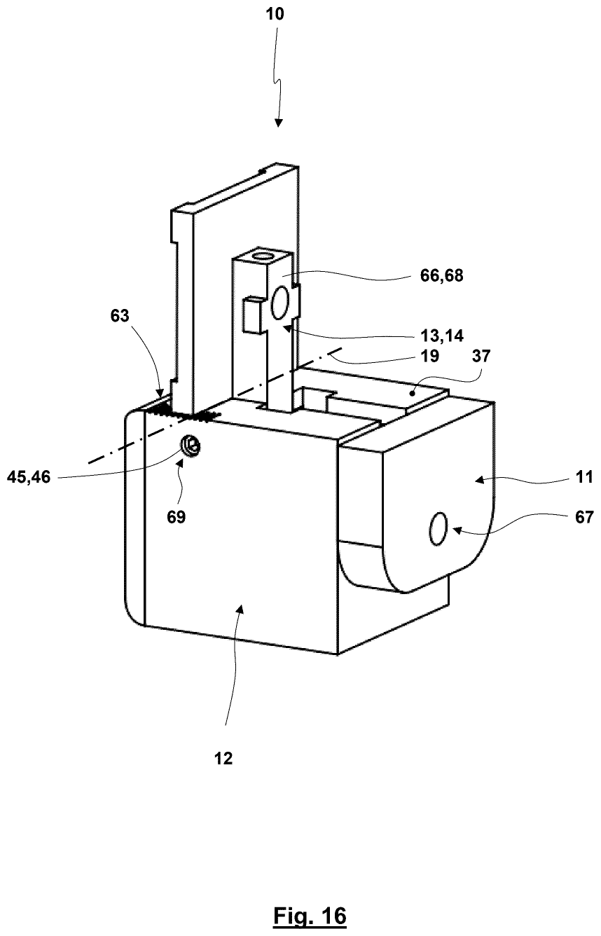

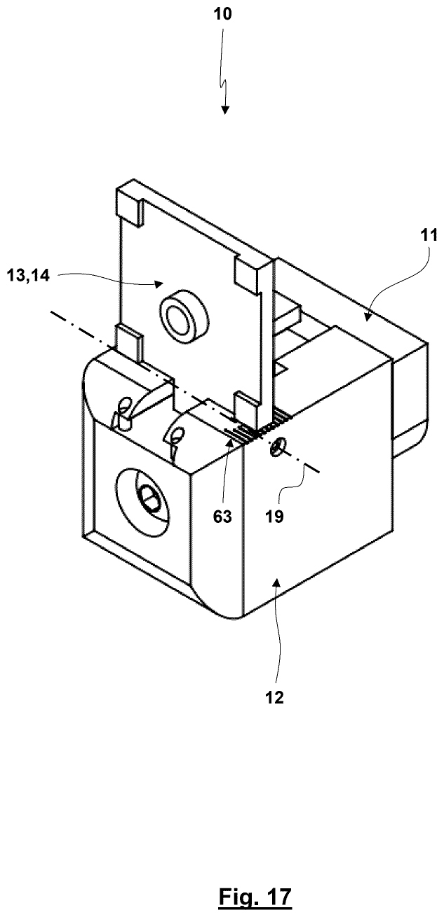

FIGS. 16 and 17 show another embodiment of a workpiece locator 10 in which the slide 13 is used directly as the positioning body 14. For this embodiment, the slide 13 is folded open about the folding axis 19 such that an underside 66 of the slide 13 is oriented parallel to the tool head plane. The underside 66 in this case forms a stop 68 for the workpiece to be processed. Preferably, the folding angle of the slide 13 relative to the side surface 37 of the holding body 12 is 90°. The folded position is then secured by a latching device 69, in particular with a latching element 45 in the form of a set screw 46.

It is possible for the workpiece locator 10 to be used exclusively in this embodiment according to FIGS. 16 and 17. It is likewise possible for the workpiece locator 10 to be used for a first application in this embodiment in which the slide 13 forms the positioning body 14. For another application, the positioning body according to the embodiments explained above can then be mounted on the slide 13, the positioning body preferably then having the rotational degree of freedom 20 relative to the slide 13.

The use of the slide 13 as a positioning body 14 as shown in FIGS. 16 and 17 can serve in particular to provide a stop 68 for a workpiece in which the connector is configured as an angle connector having two perpendicular legs, one leg having a sleeve pressed with the cable, while the other leg may have a bore for fastening to a supporting contact element. In this case, the position of the angle connector can be defined via the latter leg by this leg bearimg against the underside 66 of the slide 13.

For the embodiments shown, the T-groove 38 is formed by the holding body 12, while the slide 13 has the T-nut 51. In kinematic inversion, it is also possible for the slide 13 to form the T-groove 38, while then the T-nut 51 can be formed by the positioning body 14.

The components mentioned, in particular the supporting body 11, the holding body 12, the slide 13 and the positioning body 14, can be one-piece components or assemblies of at least two components.

As explained above, individual or several degrees of freedom can be omitted. For example, it is possible for the slide 13 to directly form the positioning body 14, in which case the rotational degree of freedom 20 and/or the folding degree of freedom 18 may not be present. In this case, the rotational degree of freedom 15 is the first degree of freedom 22, while the displacement degree of freedom 17 is the second degree of freedom 23.

It is also possible for the displacement degree of freedom 17 to be omitted, in which case the folding degree of freedom 18 or the rotational degree of freedom 20 can be the second degree of freedom 23.

The first degree of freedom 22 is provided by a first coupling mechanism 70. The second degree of freedom 23 is provided by a second coupling mechanism 71. The first and second coupling mechanisms 70, 71 might have any design for providing
a translational degree of freedom (covering a straight or curved degree of freedom) or
a rotational or folding degree of freedom.

The third and/or fourth degree of freedom 24, 25 can be provided by the first and/or second coupling mechanisms 70, 71 or by at least one additional coupling mechanism. The coupling mechanism might be provided by a pivot bearing or any linear guide, a slide, a slotted link and the like.

Many variations and modifications may be made to the preferred embodiments of the invention without departing substantially from the spirit and principles of the invention. All such modifications and variations are intended to be included herein within the scope of the present invention, as defined by the following claims.

We clam:

1. A workpiece locator for a tool being a crimping tool, pressing tool or stripping tool, the workpiece locator comprising:
a) a supporting body which is part of the tool or has a mounting region for mounting the workpiece locator to the tool,
b) a holding body which is coupled to the supporting body by a first coupling mechanism, the first coupling mechanism providing a first degree of freedom for moving the supporting body relative to the supporting body and
c) a positioning body which comprises a receptacle or a stop for a workpiece for positioning and/or aligning the workpiece to be processed with the tool,
d) wherein the positioning body is coupled to the holding body by a second coupling mechanism which provides a second degree of freedom for moving the positioning body (14) relative to the holding body.

2. The workpiece locator of claim 1, wherein the first degree of freedom of the first coupling mechanism is a rotational degree of freedom about an axis of rotation which is oriented perpendicular to a tool head plane of a tool head of the tool.

3. The workpiece locator of claim 2, wherein the holding body comprises at least two positioning bodies which are arranged distributed over a circumference of the holding body.

4. The workpiece locator of claim 1, wherein
a) the second degree of freedom of the second coupling mechanism is a rotational degree of freedom about an axis of rotation and
b) the positioning body has at least two receptacles or stops which are arranged distributed over a circumference of the positioning body.

5. The workpiece locator of claim 1, wherein the second coupling mechanism comprises a third degree of freedom for moving the positioning body relative to the holding body, the third degree of freedom being a translational displacement degree of freedom.

6. The workpiece locator of claim 5, wherein the translational displacement degree of freedom is provided by means of a slide.

7. The workpiece locator of claim 1, wherein a latching device is provided which is configured for latching the first degree of freedom of the first coupling mechanism or the second degree of freedom of the second coupling mechanism.

8. The workpiece locator of claim 6, wherein a latching device is provided which is configured for latching the translational displacement degree of freedom of the slide.

9. The workpiece locator of claim 6, wherein the translational displacement degree of freedom of the slide defines a limited slide path that is dimensioned such that an introduction of the positioning body between opened processing bodies of the tool is possible.

10. The workpiece locator of claim 9, wherein the limited slide path is dimensioned such that it is possible to push the positioning body through the opened processing bodies of the tool from one side of a tool head to the other side of the tool head.

11. The workpiece locator of claim 6, wherein the slide is guided in a T-groove of the holding body or of the positioning body, the slide having at least one T-nut which is arranged in the T-groove of the holding body.

12. The workpiece locator of claim 11, wherein the T-groove comprises an opening, the T-nut being insertable through the opening into the T-groove and being guided by the T-groove over a slide path in at least one slide path section located remote from the opening.

13. The workpiece locator of claim 6, wherein the slide forms a stop for a workpiece.

14. The workpiece locator of claim 1, wherein the second degree of freedom of the second coupling mechanism is a folding degree of freedom, by which the positioning body is foldable relative to the holding body about a folding axis.

15. The workpiece locator of claim 1, wherein the positioning body is movable relative to the holding body with a fourth degree of freedom, the fourth degree of freedom being a folding degree of freedom, by which the positioning body is foldable relative to the holding body about a folding axis.

16. The workpiece locator of claim 11, wherein
a) the positioning body is movable relative to the holding body with a fourth degree of freedom, the fourth degree of freedom being a folding degree of freedom, by which the positioning body is foldable relative to the holding body about a folding axis, and
b) the T-nut arranged in the T-groove provides the folding axis for the folding degree of freedom.

17. The workpiece locator of claim 2, wherein the first degree of freedom can be latched and is releasable in that the holding body is movable against a loading of a latching spring in a direction of the axis of rotation of the first degree of freedom away from the supporting body from a latched position into an unlatched position and is movable with the loading by the latching spring in the direction of the supporting body from the unlatched position into the latched position, wherein
a) in the latched position a latching projection of the supporting body or of the holding body is arranged in a latching recess of the holding body or supporting body, whereby the first degree of freedom is latched, and
b) in the unlatched position the latching projection of the supporting body or of the holding body is arranged outside the latching recess of the holding body or supporting body, whereby the first degree of freedom is released.

18. The workpiece locator of claim 4, wherein the second degree of freedom can be is latched and is releasable in that the positioning body is displaceable, with and against a loading of a latching spring, in the direction of the axis of rotation of the second degree of freedom between a latched position and an unlatched position, wherein
a) in the latched position a latching projection of the positioning body or of the holding body or slide is arranged in a latching recess of the holding body, of a slide or of the positioning body, whereby the second degree of freedom is latched, and
b) in the unlatched position the latching projection of the positioning body or of the holding body or of the slide is arranged outside the latching recess of the holding body, of the slide or of the positioning body, whereby the second degree of freedom is released.

19. The workpiece locator of claim 1, wherein several receptacles or stops are arranged one besides the other on a front face of the positioning body.

20. Crimping tool, pressing tool and/or stripping tool with a workpiece locator, the workpiece locator comprising:
a) a supporting body,
b) a holding body which is coupled to the supporting body by a first coupling mechanism, the first coupling mechanism providing a first degree of freedom for moving the supporting body relative to the supporting body and
c) a positioning body which comprises a receptacle or a stop for a workpiece for positioning and/or aligning the workpiece to be processed with the tool,
d) wherein the positioning body is coupled to the holding body by a second coupling mechanism which provides a second degree of freedom for moving the positioning body relative to the holding body.
